(19) United States
(12) Patent Application Publication
(10) Pub. No.: US 2026/0116307 A1
(43) Pub. Date: Apr. 30, 2026

(54) ROTARY FASTENING- TYPE HOOK ASSEMBLY FOR MOUNTING ACCESSORY OF VEHICLE

(71) Applicants: HYUNDAI MOTOR COMPANY, Seoul (KR); Kia Corporation, Seoul (KR); PIOLAX CO., LTD., Incheon (KR)

(72) Inventors: Jin-Seok YOON, Hwaseong-si (KR); Kwang-Pyo CHO, Hwaseong-si (KR); Kwang-Rae JO, Hwaseong-si (KR); Ho-Young YOON, Hwaseong-si (KR); Eun-Pyo HONG, Hwaseong-si (KR); Kang-Ho JOO, Hwaseong-si (KR); Yeon-Sim YOON, Hwaseong-si (KR); Jin-Kwan JEONG, Hwaseong-si (KR); Hye-Jin YANG, Hwaseong-si (KR); Gil-Ryun KIM, Hwaseong-si (KR); Beom-Joo JO, Hwaseong-si (KR); Joo-Hwa KIM, Hwaseong-si (KR); Jae-Eun CHANG, Hwaseong-si (KR); Han-Shin CHO, Hwaseong-si (KR); Jae-Hak YOON, Incheon (KR)

(21) Appl. No.: 19/195,098

(22) Filed: Apr. 30, 2025

(30) Foreign Application Priority Data
Oct. 28, 2024 (KR) 10-2024-0148615

(51) Int. Cl. B60R 7/00; B60R 11/00

(52) U.S. Cl. CPC B60R 7/00; B60R 2011/0019; B60R 2011/005; B60R 2011/0078; B60R 2011/008

(57) ABSTRACT

A rotary fastening-type hook assembly for a vehicle enables mounting and dismounting of various accessories by constraining the accessories to a trim of the vehicle. The rotary fastening-type hook assembly includes a hook unit that is configured to mount an accessory and includes a coupling portion disposed at a front end of the hook unit and configured to pass through a panel of the vehicle, and a backplate that coupled to a rear surface of the panel and includes a securing portion configured to couple to the coupling portion of the hook unit.

### CROSS-REFERENCE TO RELATED APPLICATION

This application claims priority to Korean Patent Application No. 10-2024-0148615, filed on Oct. 28, 2024, which is incorporated herein by reference in its entirety.

### TECHNICAL FIELD

The present disclosure relates to a rotary fastening-type hook assembly for mounting an accessory of a vehicle, which enables mounting or dismounting of various accessories by constraining the same to a vehicle trim.

### BACKGROUND

Various accessories for user convenience can be mounted on an interior of a vehicle. For example, a cup holder for holding beverages and pockets for storing various items can be mounted on an interior trim of the vehicle. In some cases, the accessories may be defined with the vehicle's interior design and provided in predetermined forms.

In some cases, depending on the user's choice, a variety of accessories may be provided. In some cases, the accessories may be provided through the aftermarket and mounted by the user.

In some cases, where the vehicle interior may not have a structure for the additional mounting of the accessories, users may use a suction cup, adhesive tape, and the like to mount the accessories. In some cases, the mounting structure may have a weak fastening strength, which may cause the accessories to move during driving, rattle noise, or the accessories' dislodgement from the trim.

In some cases, the accessories may not be firmly mounted, and the accessories may have a low load limit. In some cases, it may be difficult for users to recognize whether the accessories are fully mounted.

In some cases, in order to firmly mount the accessories, the accessories may be mounted by using a fastening bolt or the like that passes through the trim. This mounting method may be done with a separate tool, making mounting and dismounting inconvenient, and may damage the trim, reducing the aesthetics of the vehicle interior.

### SUMMARY

The present disclosure describes a rotary fastening-type hook assembly for mounting an accessory of a vehicle, which enables an accessory to be mounted to or dismounted from a vehicle trim by easily constraining the accessory to the trim without using a separate tool.

The present disclosure further describes a rotary fastening-type hook assembly for mounting an accessory of a vehicle, which enables fastening with a small amount of force, and easy recognition of fastening completion upon the completion of constraining.

The present disclosure further describes a rotary fastening-type hook assembly for mounting an accessory of a vehicle, which can prevent an accessory from moving while fastened.

According to one aspect of the subject matter described in this application, a rotary fastening hook assembly is configured to mount an accessory of a vehicle. The rotary fastening hook assembly includes a hook unit configured to mount the accessory, the hook unit including a coupling portion disposed at a front end of the hook unit and configured to pass through a panel of the vehicle, and a backplate coupled to a rear surface of the panel, the backplate including a securing portion configured to couple to the coupling portion of the hook unit through the panel. The hook unit is configured to couple to the backplate based on the coupling portion passing through the panel, being inserted into the securing portion, and then rotating relative to the backplate.

Implementations according to this aspect can include one or more of the following features. For example, the coupling portion can extend radially from a center of the hook unit, where the coupling portion has a shape corresponding to a slot defined in the panel and is configured to pass through the slot. In some examples, the backplate can include a plate portion coupled to the rear surface of the panel, and a plurality of securing portions that are arranged at intervals in the plate portion and configured to constrain the hook unit.

In some implementations, the plurality of securing portions can include a housing that is coupled to the plate portion and has a cylindrical shape, a support portion disposed at a center of the housing and configured to support the coupling portion, a connecting portion that connects an inner surface of the housing to a periphery of the support portion, and a locking portion disposed at a predetermined section of the housing and configured to restrict axial movement of the hook unit based on the locking portion overlapping with the coupling portion while the hook unit rotates relative to the backplate.

In some examples, the housing has (i) a first end adjacent to the panel and (ii) a second end disposed away from the panel in a direction in which the hook unit is inserted into the housing, where the locking portion is disposed at the first end of the housing, and the support portion and the connecting portion are disposed at the second end of the housing. The coupling portion can be configured to be constrained between the locking portion and the support portion.

In some implementations, the locking portion can include a guiding wall configured to guide an outer end of the coupling portion along a peripheral direction of the plurality of securing portions, and a guiding surface configured to seat the coupling portion and to guide rotation of the coupling portion. In some examples, a radius of the guiding wall can decrease along a direction in which the hook unit is constrained to the locking portion, where the guide wall is configured to, based on the hook unit being constrained to the locking portion, come into contact with the outer end of the coupling portion.

In some implementations, the locking portion can further include a rotation restricting portion configured to restrict rotation of the hook unit based on the hook unit being constrained to the backplate. In some examples, the support portion can include a convex portion configured to constrain the hook unit based on the hook unit being constrained to the plurality of securing portions. In some examples, the convex portion can have a mounting slope configured to contact and guide the coupling portion based on the hook unit being rotated to constrain the hook unit to the backplate, and a dismounting slope configured to contact and guide the coupling portion based on the hook unit being rotated to release the hook unit from the backplate.

In some implementations, the support portion can include a stopper that protrudes from the support portion and is configured to restrict rotation of the coupling portion based on the hook unit being constrained to the backplate. In some examples, an inclination angle of the dismounting slope can be greater than an inclination angle of the mounting slope.

In some implementations, the support portion can include a pressurizing protrusion that protrudes from the support portion, where the support portion is configured to elastically support the coupling portion based on the hook unit being constrained to the plurality of securing portions. In some examples, the coupling portion can include an insertion portion that protrudes from a center of the coupling portion and configured to be inserted into a center of the support portion.

In some implementations, the insertion portion has a conical shape and is configured to contact a region of the support portion, where the support portion can include an inclined portion disposed at the region of the support portion. In some examples, the hook unit can include a body that is a single component including an upper base, a lower base spaced apart from a bottom surface of the upper base and configured to contact a front surface of the panel, a neck portion that connects the bottom surface of the upper base to an upper surface of the lower base, the neck portion being configured to mount the accessory, the coupling portion that extends from a center of the hook unit in a radial direction of the hook unit, and a shaft that connects the lower base to the coupling portion.

In some implementations, the coupling portion can be one of a plurality of coupling portions that are arranged at intervals along a peripheral direction of the hook unit. In some examples, the hook unit can further include a manipulation ring disposed at an upper surface of the upper base and hinge-coupled to the upper base, the manipulation ring being configured to be rotated to constrain the hook unit to the backplate and release the hook unit from the backplate.

In some implementations, the hook unit can further include a cover that is fastened to an upper surface of the upper base and covers the upper surface of the upper base.

With the rotary fastening-type hook assembly for mounting an accessory of a vehicle of the present disclosure having the configuration described above, the hook assembly can be fastened to a trim without using a separate tool, thereby enabling the mounting of various accessories on the vehicle's interior by using the hook assembly.

Since the slopes formed in the convex portion are formed at different angles, the hook unit can be easily constrained to the backplate, and can easily remain constrained.

The hook assembly can constrain the hook unit to the backplate even with a small amount of force, and can be constrained by the convex portion and the stopper when mounting is completed, thereby preventing unintentional dislodgement of the hook assembly.

In addition, a contact surface of the insertion portion and the support portion is formed to be inclined, thereby preventing the hook assembly and accessories from moving.

### BRIEF DESCRIPTION OF THE DRAWINGS

FIG. 1 is a perspective view illustrating an example of a rotary fastening-type hook assembly for mounting an accessory of a vehicle, where a hook unit of the assembly is mounted on a trim of the vehicle.

FIG. 2 is an enlarged view of section A of FIG. 1.

FIG. 3 is a rear view illustrating an example of a backplate secured to a rear surface of the trim.

FIG. 4 is a side view illustrating the hook unit.

FIG. 5 is an exploded perspective view illustrating the hook unit.

FIG. 6 is a bottom perspective view illustrating a bottom surface of the hook unit.

FIG. 7 is a cutaway perspective view illustrating an example of a coupling portion of the hook unit that is constrained to a securing portion of the backplate.

FIG. 8 is a bottom view illustrating an example state in which the coupling portion of the hook unit is constrained to the securing portion of the backplate.

FIG. 9 is an enlarged view of section B of FIG. 8.

FIG. 10 is a plan view illustrating an example state in which the coupling portion of the hook unit is constrained to the securing portion of the backplate.

FIG. 11 is a perspective view illustrating an example of a mounting slope and a dismounting slope that are disposed at sides of a convex portion.

FIG. 12A and FIG. 12B are a bottom perspective view and a cross-sectional view, respectively, illustrating an example state before the constraint of the hook unit.

FIGS. 13A and 13B are a bottom perspective view and a cross-sectional view, respectively, illustrating an example state in which the constraint of the hook unit is completed.

FIG. 14 is a cross-sectional view illustrating an example of a fastening relationship between the coupling portion and a support portion.

FIG. 15 is an enlarged view of section E of FIG. 14.

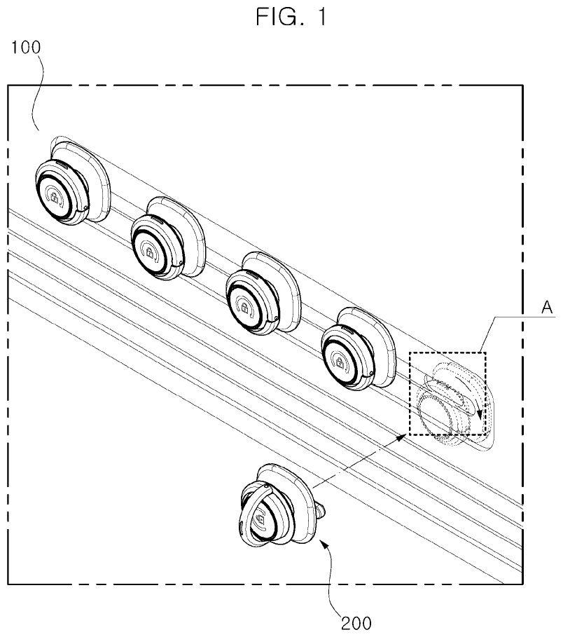

### DETAILED DESCRIPTION

Hereinafter, a rotary fastening-type hook assembly for mounting an accessory of a vehicle will be described in detail with reference to the accompanying drawings.

In some implementations, a rotary fastening-type hook assembly for mounting an accessory of a vehicle broadly includes: a hook unit 200 on which an accessory is mounted, wherein a coupling portion 215 formed at a front end of the hook unit 200 penetrates a panel 100 of a vehicle; and a backplate 300 secured to a rear surface of the panel 100, wherein a securing portion 320, to which the coupling portion 215 of the hook unit 200 penetrating the panel 100 is secured, is formed on the backplate 300.

For example, when the coupling portion 215 of the hook unit 200 penetrates the panel 100 to be inserted into the securing portion 320 and then rotates, the hook unit 200 is constrained (locked) to the backplate 300, thereby mounting the hook unit 200.

In some examples, while the hook unit 200 is constrained to the backplate 300 and the hook unit 200 is firmly fastened to the panel 100, the accessory can be mounted on the hook unit 200.

In some implementations, while the accessory is fit into the hook unit 200, the hook unit 200 can be constrained to the backplate 300, thereby enabling the accessory to be mounted on the hook unit 200.

The panel 100 forms a trim of a vehicle. For example, the panel 100 can form an interior trim of the vehicle. The hook unit 200 is mounted to be constrained to the panel 100, thereby enabling the accessory to be mounted on the hook unit 200.

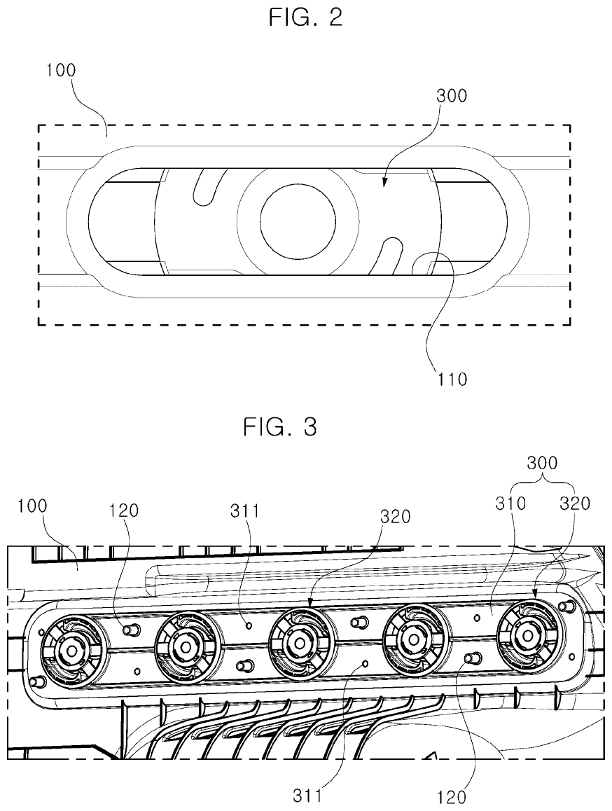

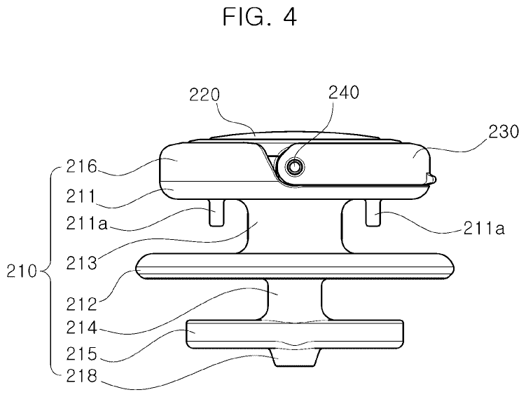

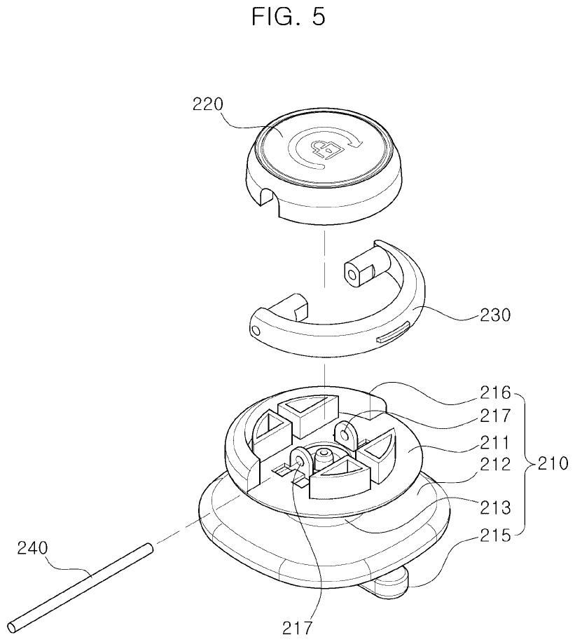

In the panel 100, a slot 110 is formed at a region where the hook unit 200 is fastened to the panel 100 for mounting the accessory (see FIG. 2). The slot 110 allows a portion of the hook unit 200, i.e., the coupling portion 215 of the hook unit 200, to pass through the panel 100 and be secured to the securing portion 320 of the backplate 300.

The slot 110 is formed to be penetrated in a shape corresponding to a shape of the coupling portion 215 such that the coupling portion 215 can pass through the slot 110. For example, as the coupling portion 215 is formed in a ‘-’ shape, the slot 110 is formed in a shape corresponding thereto. Accordingly, the coupling portion 215 in the hook unit 200 passes through the slot 110 and is constrained to the securing portion 320 of the backplate 300. Since the remaining portion of the hook unit 200 may not pass through the slot 110, the remaining portion is located on the front surface of the panel 100 and is used to mount the accessory.

A user manipulates the hook unit 200 from the front of the panel 100 to secure the hook unit 200.

The hook unit 200 includes a body 210 that can be a single component integrally injected, a cover 220 coupled to the body 210, and a manipulation ring 230 manipulated by a user.

The body 210 includes an upper base 211, a lower base 212 spaced apart from a bottom surface of the upper base 211 and in contact with the front surface of the panel 100, and a neck portion 213 connecting the upper base 211 and the lower base 212, a shaft 214 extending from a bottom surface of the lower base 212 in an axial direction of the hook unit 200, and the coupling portion 215 extending from the shaft 214 in a radial direction of the hook unit 200.

The user manipulates the upper base 211 to constrain or release the hook unit 200. The upper base 211 is provided with the manipulation ring 230 for the user to manipulate. The manipulation ring 230 is rotatably installed on an upper surface of the upper base 211 by using a hinge pin 240. The hinge pin 240 penetrates a pin accommodating portion 217 formed in the manipulation ring 230 and the upper base 211, thereby hinge-connecting the manipulation ring 230 to the upper base 211. The manipulation ring 230 is formed in a semicircle shape, such that the user can lift the manipulation ring 230 upright and rotate the same to constrain or release the hook unit 200. When the manipulation ring 230 is not in use for manipulation, the manipulation ring 230 is folded toward the upper base 211.

The cover 220 is coupled to the upper surface of the upper base 211 to cover the upper surface of the upper base 211. That is, the cover 220 covers a region where the manipulation ring 230 is connected to the upper base 211, thereby improving the exterior appearance.

An outer wall portion 216 is formed on one side of the upper base 211 to cover the remaining region where the manipulation ring 230 is not present.

A guide protrusion 211a can be formed on the bottom surface of the upper base 211 to guide the mounting of the accessory and prevent movement of the accessory when the accessory is mounted on the hook unit 200.

The lower base 212 is located to be spaced apart from the bottom surface of the upper base 211. When the hook unit 200 is constrained to the backplate 300, the bottom surface of the lower base 212 comes into contact with the front surface of the panel 100.

The neck portion 213 is formed to connect the upper base 211 and the lower base 212. The neck portion 213 is formed to have a smaller cross-sectional area than the upper base 211 and the lower base 212, such that by mounting one side of the accessory on the neck portion 213, the accessory can remain mounted on the hook unit 200.

The shaft 214 extends from the bottom surface of the lower base 212 in the axial direction of the hook unit 200. The shaft 214 becomes a center of rotation of the hook unit 200.

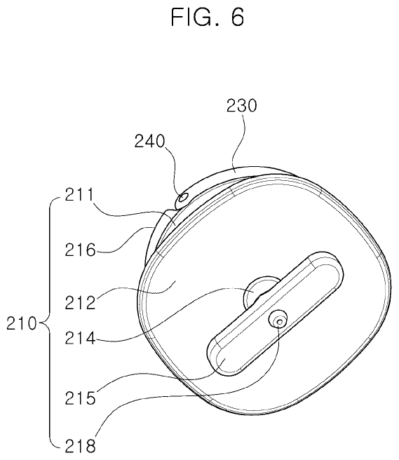

The coupling portion 215 extends from the shaft 214, i.e., a center of the hook unit 200, in the radial direction of the hook unit 200. The coupling portions 215 are formed at intervals along a peripheral direction of the shaft 214. For example, as shown in FIG. 6, the coupling portions 215 are illustrated as being formed at 180-degree intervals. The coupling portion 215 is connected to the bottom surface of the lower base 212 through the shaft 214. The coupling portion 215 is constrained to or released from the securing portion 320 of the backplate 300 by rotation of the hook unit 200.

An insertion portion 218 is formed to protrude from a bottom surface of the coupling portion 215. The insertion portion 218 is formed to be coaxially aligned with the shaft 214, such that the insertion portion 218 supports an end of the hook unit 200 during rotation of the hook unit 200. The insertion portion 218 is formed in a conical shape to have a cross-sectional area increasing from an end of the insertion portion 218 toward the coupling portion 215.

A plate portion 310, which is coupled to the rear surface of the panel 100, and the securing portions 320, which are formed at intervals in the plate portion 310 and configured to constrain the hook unit 200, are formed in the backplate 300.

The backplate 300 is secured to the rear surface of the panel 100. The backplate 300 can be secured to the rear surface of the panel 100 by forming a securing protrusion 120 on the rear surface of the panel 100, and then fusing the securing protrusion 120 after the securing protrusion 120 penetrates a fastening hole 311 formed in the plate portion 310. Alternatively, the backplate 300 can be secured to the panel 100 by forming a thread on the securing protrusion 120, and then fastening a nut to the securing protrusion 120 after the securing protrusion 120 penetrates the fastening hole 311.

The securing portions 320 are formed at intervals in the plate portion 310. The securing portions 320 are formed at the same intervals as the slots 110.

The securing portion 320 includes a housing 321 secured to the plate portion 310 and formed in a cylindrical shape, a support portion 322 located in a center of the housing 321 and configured to support the coupling portion 215, a connecting portion 323 connected to the support portion 322 on an inner surface of the housing 321, and a locking portion 324 formed in a predetermined section of the housing 321 to restrict axial movement of the hook unit 200 when the hook unit 200 rotates and overlaps the coupling portion 215.

The housing 321 is formed in a cylindrical shape and forms an outer periphery of the securing portion 320.

As the coupling portion 215 rotates inside the housing 321, the hook unit 200 can be constrained to the securing portion 320 such that the hook unit 200 can remain mounted, or can be released, thereby enabling the hook unit 200 to be dismounted.

The support portion 322 supports the coupling portion 215. By inserting the insertion portion 218 into a center of the support portion 322, the hook unit 200 can rotate while being supported on the support portion 322.

The connecting portion 323 connects the housing 321 and the support portion 322. The connecting portion 323 connects the inner surface of the housing 321 and a periphery of the support portion 322. The connecting portions 323 are formed at intervals along a peripheral direction of the securing portion 320. Since the connecting portions 323 are formed at intervals along the peripheral direction of the securing portion 320, the support portion 322 can elastically support the coupling portion 215. That is, in response to the rotation of the hook unit 200, the support portion 322 can move a certain distance along the axial direction of the hook unit 200, while elastically supporting the bottom surface of the coupling portion 215.

When the hook unit 200 rotates and overlaps the coupling portion 215, the locking portion 324 restricts the axial movement of the hook unit 200.

The locking portion 324 is formed at an end adjacent to the panel 100 in the housing 321, and the support portion 322 and the connecting portion 323 are formed at an end in a direction in which the hook unit 200 is inserted in the housing 321. Accordingly, the coupling portion 215 is constrained between the locking portion 324 and the support portion 322.

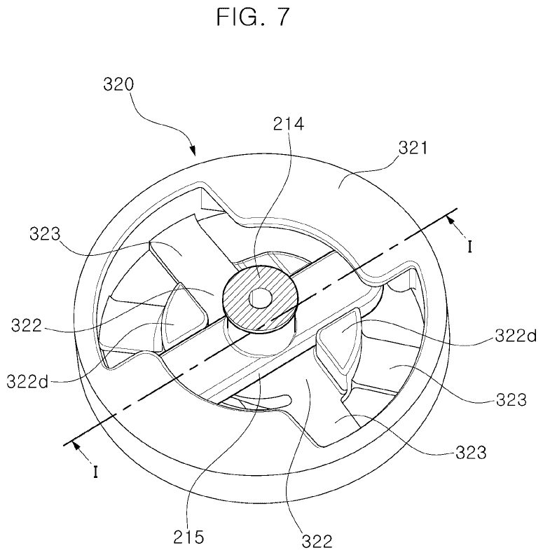

In particular, an upper surface of the housing 321 is formed with an opening, and the locking portion 324 is formed in a predetermined section. Accordingly, the coupling portion 215 is not dismounted from the securing portion 320 in the section where the locking portion 324 is formed. Referring to FIG. 7, it is illustrated that in the housing, the locking portion 324 is formed in a 90-degree section along a peripheral direction of the housing 321, and that the locking portion 324 is not formed in a subsequent 90-degree section. Through the section where the locking portion 324 is not formed, the coupling portion 215 can enter or exit an interior of the securing portion 320; and by rotating in the section where the locking portion 324 is formed, axial movement of the coupling portion 215 relative to the securing portion 320 can be constrained or released.

In the locking portion 324, a guiding wall 324a is formed to guide an outer end of the coupling portion 215 along the peripheral direction of the securing portion 320, and a guiding surface 324b, on which the coupling portion 215 is seated, is formed to guide rotation of the coupling portion 215.

When constrained or released, the coupling portion 215 can rotate in a stable state while being in contact with the guiding surface 324b.

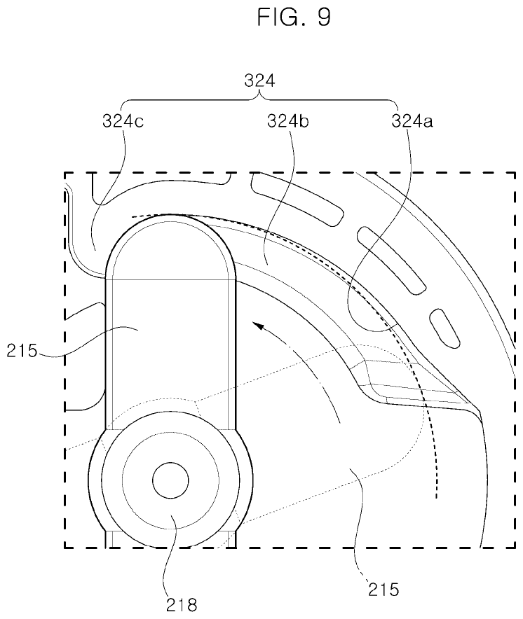

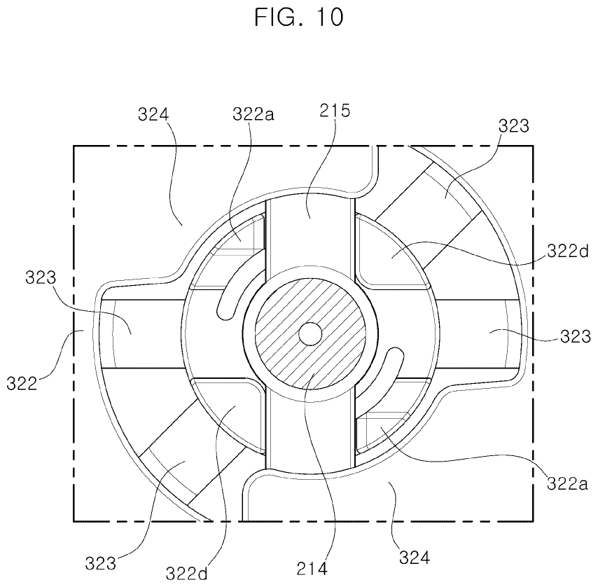

The guiding wall 324a is formed to decrease in radius along a direction in which the hook unit 200 is constrained. Referring to FIG. 9, the dotted line is a perfect circle arc centered on the support portion 322 to visualize the decrease of the radius of the guiding wall 324a. As the coupling portion 215 rotates in the direction in which the coupling portion 215 is constrained (counterclockwise), the guiding wall 324a converges to the dotted line. In particular, when the constraint of the hook unit 200 is completed, the guiding wall 324a comes into contact with the outer end of the coupling portion 215. This is to facilitate the initial phase of rotation of the coupling portion 215, while firmly securing the coupling portion 215 in the final phase of rotation, when the coupling portion 215 is inserted into the securing portion 320 to mount the hook unit 200.

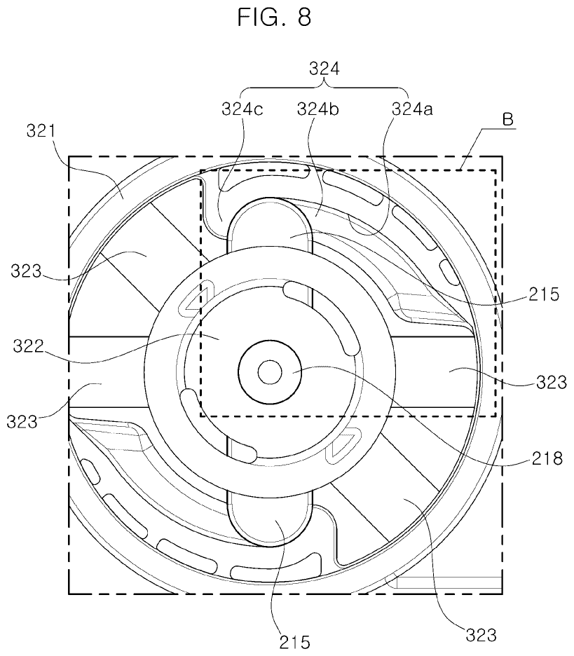

A rotation restricting portion 324c is formed in the locking portion 324, wherein the rotation restricting portion 324c restricts the rotation of the hook unit 200 when the constraint of the hook unit 200 is completed. That is, as shown in FIGS. 8 and 9, further rotation is restricted in the counterclockwise direction.

In some examples, the locking portion 324 can restrict the hook unit 200 from moving axially, but may not maintain the state. Accordingly, the support portion 322 forms a convex portion 322a to maintain a state in which the constraint of the hook unit 200 is completed.

The convex portion 322a is formed to protrude from the support portion 322. Accordingly, when the coupling portion 215 rotates and passes over the convex portion 322a to constrain the hook unit 200, the rotation is restricted, such that the hook unit 200 remains constrained. Alternatively, when the coupling portion 215 rotates to release the hook unit 200, the coupling portion 215 passes over the convex portion 322a, such that the hook unit 200 becomes released.

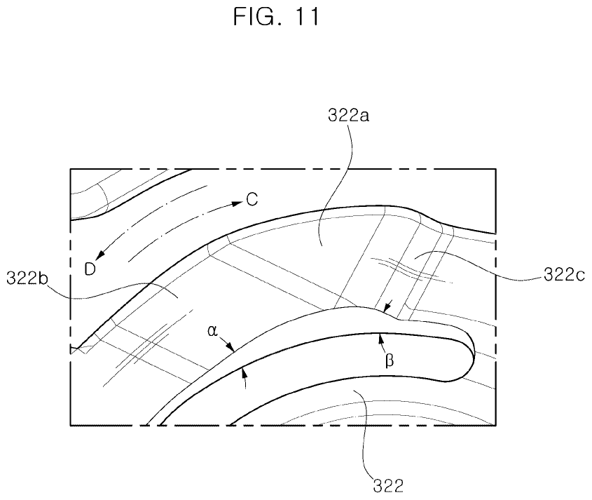

A slope is formed on the convex portion 322a along a peripheral direction of the support portion 322, such that the coupling portion 215 can come into contact with and pass over the convex portion 322a. That is, a mounting slope 322b, on which the coupling portion 215 is seated and transferred when rotating (arrow C in FIG. 11) to constrain the hook unit 200, is formed; and a dismounting slope 322c, on which the coupling portion 215 is seated and transferred when rotating (arrow D in FIG. 11) to release the hook unit 200, is formed.

In this case, an inclination angle β of the dismounting slope 322c is formed to be greater than an inclination angle α of the mounting slope 322b. The inclination angle α of the mounting slope 322b is smaller because when the hook unit 200 is rotated to be constrained, the hook unit 200 can be easily rotated and constrained even with a small amount of rotational force (e.g., force applied by a hand or fingers), such that the hook unit 200 can be manipulated with a small amount of manipulating force. The inclination angle β of the dismounting slope 322c is formed greater because when the hook unit 200 is constrained, while easily maintaining the hook unit 200 in a constrained state, the hook unit 200 can be manipulated with a larger amount of manipulating force when being rotated and released.

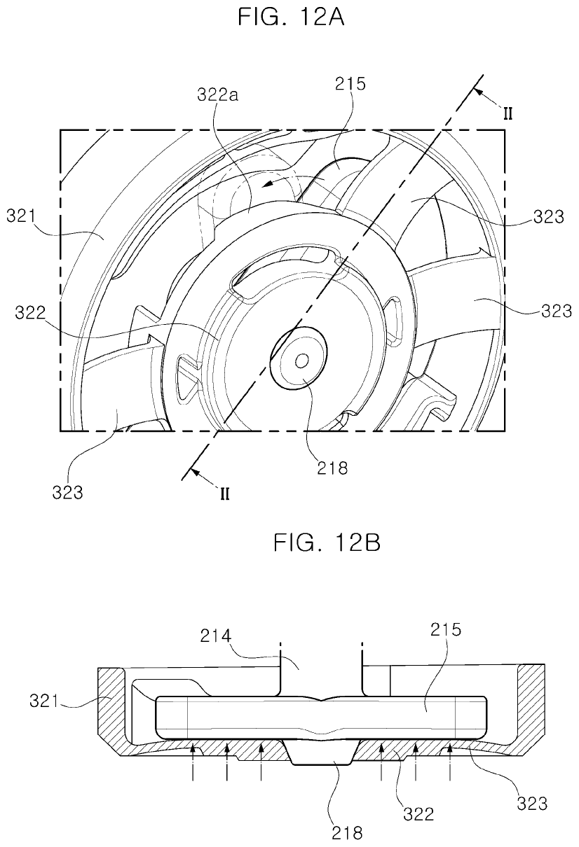

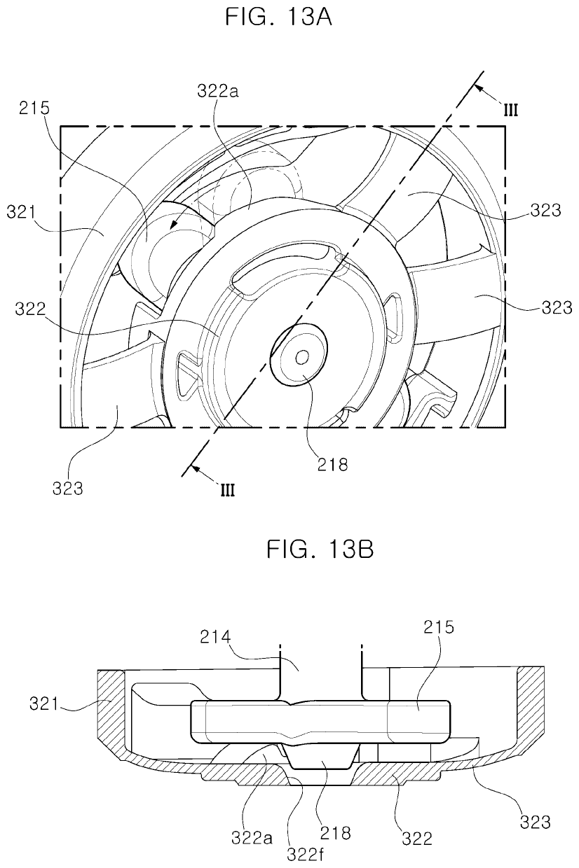

The convex portion 322a is formed to protrude from the support portion 322. Accordingly, when the coupling portion 215 enters the interior of the securing portion 320, the support portion 322 elastically supports the coupling portion 215 (see FIGS. 12A and 12B). In this state, when the hook unit 200 is rotated, the support portion 322 and the connecting portion 323 are deformed toward an end of the insertion portion 218, while elastically supporting the bottom surface of the coupling portion 215 (see FIGS. 13A and 13B).

In addition, a stopper 322d that restricts the rotation of the coupling portion 215 is formed on the support portion 322. The stopper 322d is formed to protrude from the support portion 322 to restrict the rotation of the coupling portion 215 when the constraint of the hook unit 200 is completed. The coupling portion 215 is located between the dismounting slope 322c and the stopper 322d to remain constrained.

When the coupling portion 215 passes through the mounting slope 322b and the convex portion 322a and is located on the dismounting slope 322c, a sound is produced as the coupling portion 215 moves to the dismounting slope 322c, and an elastic force acting on the coupling portion 215 changes. Accordingly, the user can easily recognize that the mounting of the hook unit 200 is completed.

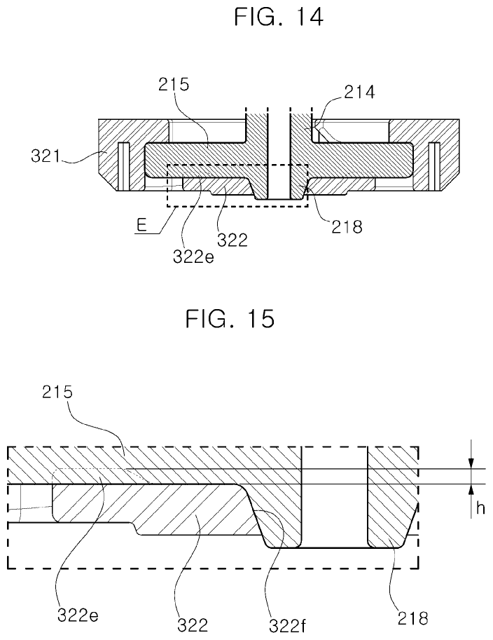

In addition, a pressurizing protrusion 322e is formed in the support portion 322, such that when the hook unit 200 is constrained to the securing portion 320, the support portion 322 elastically supports the coupling portion 215. The pressurizing protrusion 322e is formed to protrude from the support portion 322. Accordingly, as illustrated in FIGS. 14 and 15, when the hook unit 200 is constrained, an overlap occurs by a height h of the pressurizing protrusion 322e, such that the support portion 322 exerts a continuous elastic force to pressurize the coupling portion 215.

In addition, an inclined portion 322f is formed at a region where the insertion portion 218 comes into contact with the support portion 322. Since the insertion portion 218 is formed in a conical shape, the support portion 322 and the insertion portion 218 come into contact with each other with an inclined surface. Accordingly, when the constraint of the hook unit 200 is completed, the coupling portion 215 is supported by an elastic force to detect a mounting position. In addition, the insertion portion 218 and the inclined portion 322f remain in constant contact with each other, thereby preventing rattle caused by the hook unit 200 and the securing portion 320 not being in close contact.

The following is the description of a process of mounting the hook unit 200 in the rotary fastening-type hook assembly for mounting an accessory of a vehicle of the present disclosure having the configuration described above.

The hook unit 200 is aligned to be adjacent to the slot 110 such that the hook unit 200 is mounted on the panel 100.

A user grasps the upper base 211 of the hook unit 200 such that the coupling portion 215 penetrates the slot 110 and is inserted into the securing portion 320 of the backplate 300.

The slot 110 is formed to correspond to a shape of the coupling portion 215. Accordingly, when the coupling portion 215 is inserted while aligned with the slot 110, the coupling portion 215 penetrates the slot 110 and is inserted into the securing portion 320.

The securing portion 320 also has the locking portion 324 formed in some section on an upper end of the housing 321, but the locking portion 324 is not formed in the remaining section. Accordingly, the coupling portion 215 is inserted into the interior of the securing portion 320 through the section where the locking portion 324 is not formed. In a state where the coupling portion 215 is inserted into the securing portion 320, the coupling portion 215 is located between the locking portion 324 and the support portion 322, with respect to the axial direction of the hook unit 200.

In a state where the coupling portion 215 is seated on the support portion 322, that is, in a state where the insertion portion 318 is inserted into the support portion 322, the hook unit 200 is rotated to constrain the hook unit 200 to the securing portion 320. In this case, in order to easily rotate the hook unit 200, the manipulation ring 230 can be lifted upright and then rotated, such that the hook unit 200 can be easily rotated.

In a state where the coupling portion 215 is inserted into the securing portion 320, the outer end of the coupling portion 215 is outside of the locking portion 324. In some cases, when the hook unit 200 rotates, the coupling portion 215 is inserted into the locking portion 324, such that the outer end of the coupling portion 215 is guided by the locking portion 324. That is, since the guiding wall 324a is formed to decrease in radius along a direction in which the hook unit 200 is constrained, the hook unit 200 can easily rotate by being spaced apart from the outer end of the coupling portion 215 at the initial phase of the rotation. In addition, as the hook unit 200 rotates, a gap between the outer end of the coupling portion 215 and the guiding wall 324a narrows; and when the rotation of the hook unit 200 is completed, the outer end of the coupling portion 215 comes into contact with the guiding wall 324a without a gap. In addition, the coupling portion 215 can be caught by the rotation restricting portion 324c and not rotate any further.

In addition, the coupling portion 215 is constrained by the support portion 322. That is, when the hook unit 200 is rotated, the coupling portion 215 moves along the mounting slope 322b and passes over the convex portion 322a to be located between the dismounting slope 322c and the stopper 322d. The mounting slope 322b is gradual, such that even when the hook unit 200 is rotated with a small amount of manipulating force, the hook unit 200 can be easily rotated, such that the coupling portion 215 can move along the mounting slope 322b. When the coupling portion 215 is located between the dismounting slope 322c and the stopper 322d, the coupling portion 215 can no further rotate in which the hook unit 200 is completely mounted on the panel 100. The dismounting slope 322c is steep, such that the coupling portion 215 is located between the dismounting slope 322c and the stopper 322d until a large amount of rotational force is applied.

In this case, the user can easily recognize the completion of the mounting of the hook unit 200 through a change in sound and elastic force.

The coupling portion 215 is elastically supported toward the lower base 212 by the support portion 322 and the connecting portion 323 at the initial stage of mounting the hook unit 200. Accordingly, the support portion 322 and the connecting portion 323 bring the coupling portion 215 into close contact with the lower base 212 (see FIGS. 12A and 12B).

Then, when the hook unit 200 rotates, the coupling portion 215 moves along the mounting slope 322b, the convex portion 322a, and the dismounting slope 322c, such that the coupling portion 215 pushes against the support portion 322, but the support portion 322 and the connecting portion 323 are deformed to become convex downward, while elastically supporting the coupling portion 215 (see FIGS. 13A and 13B).

When the hook unit 200 is completely mounted on the panel 100 in this way, the user can mount an accessory on the hook unit 200 for use.

A plurality of the slots 110 can be formed in the panel 100, and the securing portion 320 can be formed in the backplate 300 to correspond to a location of each of the slots 110. Accordingly, the hook unit 200 can be mounted by adjusting a location of the hook unit 200 depending on a location of the accessory. In addition, depending on a load of the accessory, a plurality of the hook units 200 can be mounted, and the accessory can be mounted using the same.

In some examples, if the hook unit 200 is to be dismounted, when the hook unit 200 is rotated in the opposite direction, while rotating in the opposite direction to when mounted, the coupling portion 215 passes through the dismounting slope 322c and the convex portion 322a on the support portion 322, and then moves along the mounting slope 322b. In addition, the coupling portion 215 is also dismounted from the locking portion 324, such that the coupling portion 215 becomes movable in the axial direction of the hook unit 200. In this state, the user pulls the hook unit 200 to dismount the hook unit 200 from the panel 100.

What is claimed is:

1. A rotary fastening hook assembly configured to mount an accessory for a vehicle, the rotary fastening hook assembly comprising:
a hook unit configured to mount the accessory, the hook unit comprising a coupling portion disposed at a front end of the hook unit and configured to pass through a panel of the vehicle; and
a backplate coupled to a rear surface of the panel, the backplate comprising a securing portion configured to couple to the coupling portion of the hook unit through the panel,
wherein the hook unit is configured to couple to the backplate based on the coupling portion passing through the panel, being inserted into the securing portion, and then rotating relative to the backplate.

2. The rotary fastening hook assembly of claim 1, wherein the coupling portion extends radially from a center of the hook unit, and
wherein the coupling portion has a shape corresponding to a slot defined in the panel and is configured to pass through the slot.

3. The rotary fastening hook assembly of claim 1, wherein the backplate comprises:
a plate portion coupled to the rear surface of the panel; and
a plurality of securing portions that are arranged at intervals in the plate portion and configured to constrain the hook unit.

4. The rotary fastening hook assembly of claim 3, wherein the plurality of securing portions comprise:
a housing that is coupled to the plate portion and has a cylindrical shape;
a support portion disposed at a center of the housing and configured to support the coupling portion;
a connecting portion that connects an inner surface of the housing to a periphery of the support portion; and
a locking portion disposed at a predetermined section of the housing and configured to restrict axial movement of the hook unit based on the locking portion overlapping with the coupling portion while the hook unit rotates relative to the backplate.

5. The rotary fastening hook assembly of claim 4, wherein the housing has (i) a first end adjacent to the panel and (ii) a second end disposed away from the panel in a direction in which the hook unit is inserted into the housing,
wherein the locking portion is disposed at the first end of the housing,
wherein the support portion and the connecting portion are disposed at the second end of the housing, and
wherein the coupling portion is configured to be constrained between the locking portion and the support portion.

6. The rotary fastening hook assembly of claim 4, wherein the locking portion comprises:
a guiding wall configured to guide an outer end of the coupling portion along a peripheral direction of the plurality of securing portions; and
a guiding surface configured to seat the coupling portion and to guide rotation of the coupling portion.

7. The rotary fastening hook assembly of claim 6, wherein a radius of the guiding wall decreases along a direction in which the hook unit is constrained to the locking portion, and
wherein the guide wall is configured to, based on the hook unit being constrained to the locking portion, come into contact with the outer end of the coupling portion.

8. The rotary fastening hook assembly of claim 6, wherein the locking portion further comprises a rotation restricting portion configured to restrict rotation of the hook unit based on the hook unit being constrained to the backplate.

9. The rotary fastening hook assembly of claim 4, wherein the support portion comprises a convex portion configured to constrain the hook unit based on the hook unit being constrained to the plurality of securing portions.

10. The rotary fastening hook assembly of claim 9, wherein the convex portion has:
a mounting slope configured to contact and guide the coupling portion based on the hook unit being rotated to constrain the hook unit to the backplate; and
a dismounting slope configured to contact and guide the coupling portion based on the hook unit being rotated to release the hook unit from the backplate.

11. The rotary fastening hook assembly of claim 10, wherein the support portion comprises a stopper that protrudes from the support portion and is configured to restrict rotation of the coupling portion based on the hook unit being constrained to the backplate.

12. The rotary fastening hook assembly of claim 10, wherein an inclination angle of the dismounting slope is greater than an inclination angle of the mounting slope.

13. The rotary fastening hook assembly of claim 4, wherein the support portion comprises a pressurizing protrusion that protrudes from the support portion, and
wherein the support portion is configured to elastically support the coupling portion based on the hook unit being constrained to the plurality of securing portions.

14. The rotary fastening hook assembly of claim 4, wherein the coupling portion comprises an insertion portion that protrudes from a center of the coupling portion and configured to be inserted into a center of the support portion.

15. The rotary fastening hook assembly of claim 14, wherein the insertion portion has a conical shape and is configured to contact a region of the support portion, and
wherein the support portion comprises an inclined portion disposed at the region of the support portion.

16. The rotary fastening hook assembly of claim 1, wherein the hook unit comprises a body that is a single component comprising:
an upper base;
a lower base spaced apart from a bottom surface of the upper base and configured to contact a front surface of the panel;
a neck portion that connects the bottom surface of the upper base to an upper surface of the lower base, the neck portion being configured to mount the accessory;
the coupling portion that extends from a center of the hook unit in a radial direction of the hook unit; and
a shaft that connects the lower base to the coupling portion.

17. The rotary fastening hook assembly of claim 16, wherein the coupling portion is one of a plurality of coupling portions that are arranged at intervals along a peripheral direction of the hook unit.

18. The rotary fastening hook assembly of claim 16, wherein the hook unit further comprises:
a manipulation ring disposed at an upper surface of the upper base and hinge-coupled to the upper base, the manipulation ring being configured to be rotated to constrain the hook unit to the backplate and release the hook unit from the backplate.

19. The rotary fastening hook assembly of claim 16, wherein the hook unit further comprises a cover that is fastened to an upper surface of the upper base and covers the upper surface of the upper base.
